(19) United States
(12) Patent Application Publication
(10) Pub. No.: US 2003/0101336 A1
(43) Pub. Date: May 29, 2003

(54) Technique for associating instructions with execution events

(75) Inventors: Nicolai Kosche, San Francisco, CA (US); Brian J. Wylie, Palo Alto, CA (US); Christopher P. Aoki, Los Altos, CA (US); Peter C. Damron, Fremont, CA (US)

Correspondence Address: ZAGORIN O'BRIEN & GRAHAM LLP, 401 W 15TH STREET, SUITE 870, AUSTIN, TX, 78701, US

(73) Assignee: Sun Microsystems, Inc.

(21) Appl. No.: 10/050,358

(22) Filed: Jan. 16, 2002

Related U.S. Application Data
(60) Provisional application No. 60/333,858, filed on Nov. 28, 2001.

(51) Int. Cl. G06F 15/00

(52) U.S. Cl. 712/244

(57) ABSTRACT

Program code executed in an environment in which latency exists between an execution event and detection of the execution event may be profiled using a technique that includes backtracking from a point in a representation of the program code, which coincides with the detection toward a preceding operation associated with the execution event. Backtracking identifies the preceding operation at a displacement from the detection point unless an ambiguity creating location is disposed between the detection point and the preceding operation. In general, the relevant set of ambiguity creating locations is processor implementation dependent and program code specific; however, branch targets locations, entry points, and trap or interrupt handler locations are common examples. In some realizations, the techniques may be used to associate cache miss (or hit) information with execution of particular memory access instructions. However, more generally, such techniques may be employed to associate observed execution characteristics with particular instructions of program code or associated operations based on event detections that may, in general, lag execution of the triggering instruction or operation by an interval that allows intervening program flow ambiguity.

### CROSS REFERENCE TO RELATED APPLICATIONS

This application is related to (1) U.S. Patent Application No. 09/996,088 entitled “AGGRESSIVE PREFETCH OF ADDRESS CHAINS,” naming Peter Damron and Nicolai Kosche as inventors, and filed Nov. 28,2001 and to (2) U.S. patent application No. xx/xxx,xxx [Att'y Dkt. No. 004-7051] entitled “TECHNIQUE FOR ASSOCIATING EXECUTION CHARACTERISTICS WITH INSTRUCTIONS OR OPERATIONS OF PROGRAM CODE,” naming Nicolai Kosche, Christopher P. Aoki and Peter C. Damron as inventors, filed on even date herewith. Each of the related applications is incorporated herein by reference in its entirety.

### BACKGROUND

1. Field of the Invention

The present invention relates to techniques to associate execution characteristics of program code with particular instructions or operations thereof and, in particular, to techniques that tolerate lags in the detection of execution events.

2. Description of the Related Art

Code profiling techniques have long been used to gain insight into execution performance of computer programs. Often, such insights are valuable and allow programmers to improve the execution performance of their computer programs. Indeed, a large body of work exists in the field of profiling. In general, two major classes of techniques exist: code instrumentation and hardware assisted profiling. Code instrumentation techniques typically include the insertion of instructions into the instruction stream of a program to be profiled. In crude form, programmer insertion of printf source statements may be employed to profile code. More sophisticated approaches may employ compiler facilities or options to insert appropriate instruction or operations to support profiling. Upon execution of the instrumented code, execution characteristics are sampled, in part by operation of the added instructions. Typically, code instrumentation techniques impose overhead on original program code so instrumented and, unfortunately, the insertion of instructions into the instruction stream may itself alter the behavior of the program code being sampled.

Hardware assisted profiling techniques have been developed, in part, to address such limitations by off loading some aspects to dedicated hardware such as event counters. Practical implementations often employ aspects of code instrumentation and hardware assistance. In some cases, profiling support is included in, or patched into, exception handler code to avoid imposing overhead on each execution of a sampled instruction. Suitable hardware event counters are provided in advanced processor implementations such as those in accordance with the SPARC® and Alpha processor architectures. SPARC architecture based processors are available from Sun Microsystems, Inc, Palo Alto, Calif. SPARC trademarks are used under license and are trademarks or registered trademarks of SPARC International, Inc. in the United States and other countries. Products bearing SPARC trademarks are based upon an architecture developed by Sun Microsystems. Systems that include Alpha processors are available from a number of sources including Compaq Computer Corporation.

One reasonably comprehensive hardware assisted profiling environment is provided by the Digital Continuous Profiling Infrastructure (DCPI) tools that run on Alpha processor systems to provide profile information at several levels of granularity, from whole images down to individual procedures and basic blocks on down to detailed information about individual instructions, including information about dynamic behavior such as cache misses, branch mispredicts and other forms of dynamic stalls. Detailed information on the DCPI tools and downloadable code may be found (at least as of the filing date) at http://www.research.digital.com/SRC/dcpi or at http://www.tru64unix.compaq.com/dcpi. Additional descriptive information appears in Jennifer Anderson, Lance Berc, George Chrysos, Jeffrey Dean, Sanjay Ghemawat, Jamey Hicks, Shun-Tak Leung, Mitch Lichtenberg, Mark Vandevoorde, Carl A. Waldspurger, William E. Weihl, “Transparent, Low-Overhead Profiling on Modern Processors,” in Proceedings of the Workshop on Profile and Feedback-Directed Compilation in conjunction with the International Conference on Parallel Architectures and Compilation Techniques (PACT 98), Paris, France (Oct. 13, 1998).

While the DCPI tools purport to attribute instruction-level stall information to the instructions that actually incur such stalls, precise attribution may, in practice, be difficult to achieve in many implementations. Hardware counter overflows are often used to provide a low-overhead in statistical sampling component to a profiling mechanism. However, in many processor implementations (particularly heavily pipelined processor implementations), a hardware counter overflow signal tends to lag a sampled instruction execution or other triggering event. This delay, sometimes referred to as program counter skid, can make precise identification of an associated instruction difficult. Accordingly, techniques are needed that facilitate reliable identification of instructions associated with execution events even in the presence of a detection lag.

### SUMMARY

It has been discovered that program code executed in an environment in which latency exists between an execution event and detection of the execution event may be profiled using a technique that includes backtracking from a point in a representation of the program code, which coincides with the detection toward a preceding operation associated with the execution event. Backtracking identifies the preceding operation at a displacement from the detection point unless an ambiguity creating location is disposed between the detection point and the preceding operation. In general, the relevant set of ambiguity creating locations is processor implementation dependent and program code specific; however, branch targets locations, entry points, and trap or interrupt handler locations are common examples. In some realizations, the techniques may be used to associate cache miss (or hit) information with execution of particular memory access instructions. However, more generally, such techniques may be employed to associate observed execution characteristics with particular instructions of program code or associated operations based on event detections that may, in general, lag execution of the triggering instruction or operation by an interval that allows intervening program flow ambiguity.

### BRIEF DESCRIPTION OF THE DRAWINGS

The present invention may be better understood, and its numerous objects, features, and advantages made apparent to those skilled in the art by referencing the accompanying drawings.

FIG. 1 depicts functional units of an illustrative processor architecture in which pipeline depth may contribute to delayed detection of profiled execution events.

FIG. 2 depicts an instruction sequence that includes a target load instruction for which association of a detected cache miss execution event may be complicated by presence of an ambiguity creating location between the target load instruction and a point in the instruction sequence that coincides with detection of the cache miss.

FIG. 3 is a flow chart of a process in accordance with some embodiments of the present invention by which an instruction sequence is prepared for profiling, profile data is collected and optimized code is prepared (or re-prepared) based thereon. For purposes of illustration, instruction identification, collection and code optimization are depicted as separable phases although they need not be in all realizations.

FIG. 4 is a flow chart illustrating techniques in accordance with some embodiments of the present invention whereby executable code is prepared for profiling (e.g., by a feedback directed optimizing compiler) in which certain later stages of optimization are initially forgone, then, based on profile data obtained, are performed to generate optimized program code. In general, the forgone optimizations may include those that are based on profile information and those that tend to complicate or interfere with data collection and/or association with instructions.

FIG. 5 is a flow chart illustrating techniques in accordance with some embodiments of the present invention whereby target instructions are associated with event detections using backtracking.

FIG. 6 is a flow chart illustrating preparation, in accordance with some embodiments of the present invention, of an instruction sequence that includes an unambiguous skid region to support facilitate profiling.

FIG. 7 depicts an instruction sequence that includes one or more instructions that provide an unambiguous skid region in accordance with some embodiments of the present invention.

### The use of the same reference symbols in different drawings indicates similar or identical items.

### DESCRIPTION OF THE PREFERRED EMBODIMENT(S)

The description that follows includes exemplary systems, methods, techniques, instruction sequences and computer program products that embody techniques of the present invention. In some realizations, instruction sequences and computer program products in accordance with the present invention are made using such techniques. For purposes of description, certain aspects of the present invention are detailed in the context of instruction sequences that include load-type memory access instructions with which cache miss execution events may be associated using backtracking techniques. More generally, other target instructions or operations may be associated with execution events using techniques of the present invention. In much of the description that follows, branch target locations are illustrative instances of the general class of ambiguity creating locations. However, more generally, other program constructs may create ambiguity when interposed between a target instruction or operation and a point in the instruction sequence coinciding with detection of an execution event.

Accordingly, in view of the above and without limitation, the description that follows focuses on a particular illustrative context in which delayed detections of cache miss events are associated with corresponding memory access instructions, while considering, obviating or mitigating effects of intervening, ambiguity creating branch target locations. Other exploitations and realizations will be understood in the context of the description and the claims that follow.

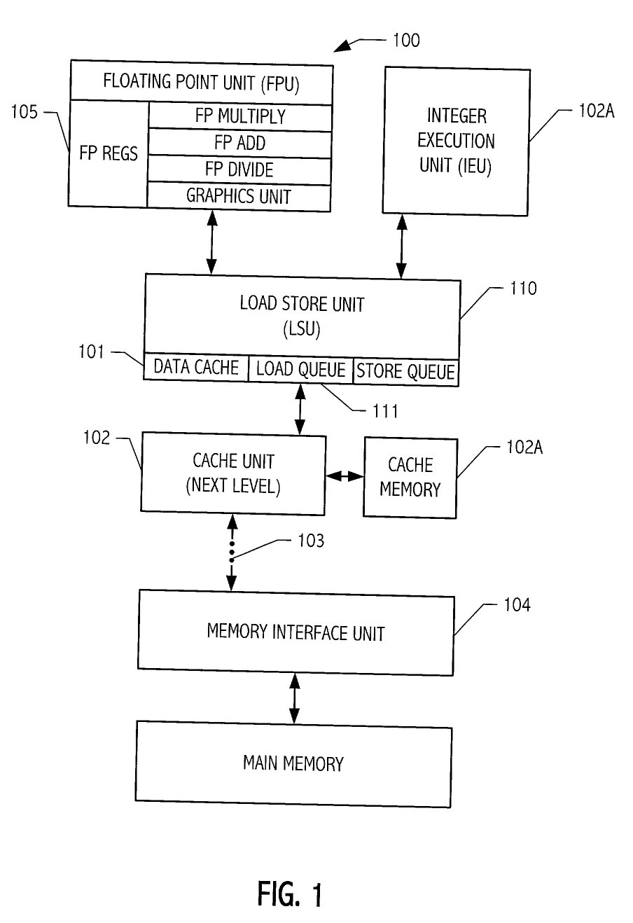

FIG. 1 depicts functional units of an illustrative processor 100 in which pipeline depth may contribute to delayed detection of execution events such as cache misses. Profile-directed compilation techniques may be employed to prepare and/or optimize code for execution on processor 100 and, in some embodiments in accordance with the present invention, backtracking techniques may be employed to associate such execution events (or aggregations thereof) with particular instructions of the code and thereby guide code optimizations. For example, processor 100 includes a memory hierarchy for which latencies of some memory access instructions may be at least partially hidden using judicious placement of prefetch instructions as long as likely cache misses or other likely to stall conditions can be identified. Techniques in accordance with the present invention are particularly useful for the associating of delayed detections of cache misses with particular instructions so that cache miss likelihoods can be estimated.

The memory hierarchy of processor 100 includes an on-board data cache 101 associated with a load/store unit 110 of the processor as well as a next level cache 102, 102A, main memory 104 and any intervening levels 103 (not specifically shown) of additional cache or buffering. Persons of ordinary skill in the art will appreciate that in such hierarchies, latencies for memory accesses serviced from main memory rather than from cache, can be substantial. Accordingly, the payoff for reliably estimating cache miss likelihoods and, where possible hiding memory access latency, can be significant. While any of a variety of optimizations may benefit from techniques of the present invention, prefetch optimizations are illustrative. In this regard, co-pending U.S. patent application Ser. No. 09/996,088, entitled “AGGRESSIVE PREFETCH OF ADDRESS CHAINS,” naming Peter C. Damron and Nicolai Kosche as inventors and filed Nov. 28, 2001, the entirety of which is incorporated herein by reference, describes illustrative prefetch techniques that may benefit from techniques of the present invention that facilitate the association of instructions or operations with execution events, even in the presence of detection latencies. In particular, the above-incorporated patent application describes prefetch optimizations that exploit memory access latencies of “martyr operations.” Candidate martyr operations, including likely-to-miss cache memory access instructions may be identified using techniques in accordance with the present invention.

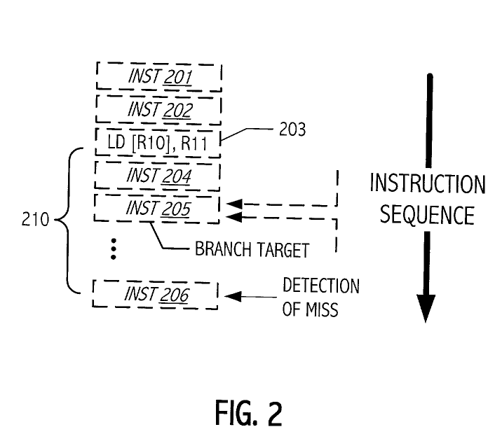

FIG. 2 illustrates an instruction sequence executable on a processor such as that illustrated in FIG. 1. The instruction sequence includes a load instruction 203 for which association of a detected cache miss execution event may be complicated by the presence of an ambiguity creating location. Absent the ambiguity creating location, backtracking from the miss detection to load instruction 203 is straightforward. However, in the illustrated case, interposed instruction 205 is a branch target of one or more branch or control transfer instructions (not specifically shown). Because detection of a cache miss corresponding to load instruction 203 is delayed (e.g., by detection lag 210), and because the branch target location is interposed between the target load instruction and a point in the instruction sequence (namely, instruction 206) that coincides with detection of the cache miss, execution path ambiguity complicates the association of the detected cache miss with load instruction 203. Absent additional information, it is unclear whether the actual execution that caused the cache miss took a path that includes instructions 203, 204, 205, . . . 206, or whether actual execution arrived at instruction 205 via a branch or other control transfer. In the latter case, some memory access instruction other than load instruction 203 caused the detected cache miss and it should not be associated with instruction 203.

Realizations in accordance with the present invention may handle the above-described ambiguity in any of a variety of ways. For example, in some realizations, ambiguity-creating locations are identified and execution event detections so-affected are simply ignored in code profiling. In this way, only non-ambiguous detections are included in data collection results. In some realizations, additional information (such as from a branch history queue maintained by the processor or ancillary to the profiling implementation) can be employed to bridge certain ambiguity-creating locations. For example, using data from a branch history queue, execution paths through at least some otherwise ambiguous locations can be better determined. In some realizations, programming constructs that would otherwise create execution path ambiguity may be obviated by insertion of padding instructions sufficient to provide an unambiguous skid region, thereby covering the expected detection lag.

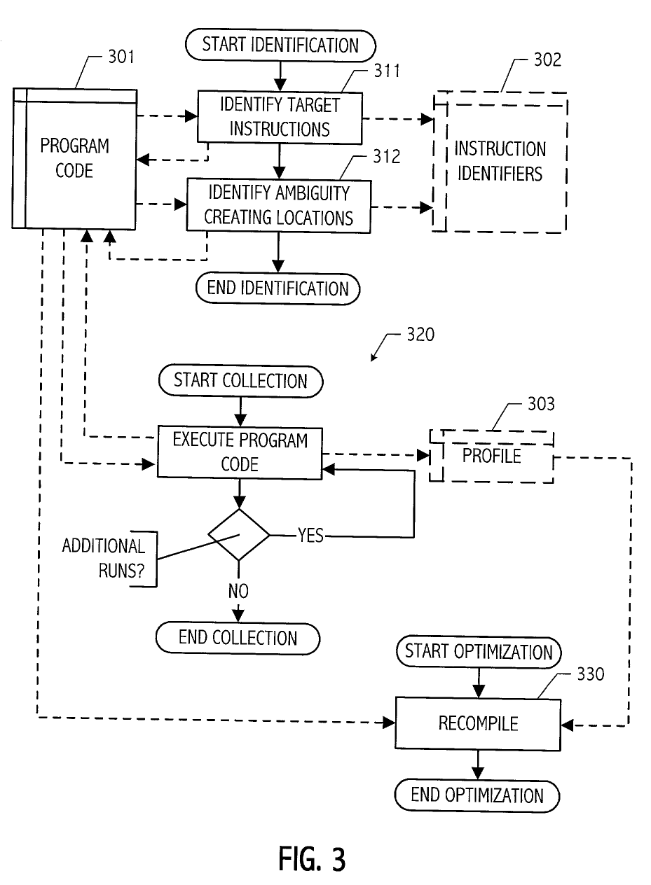

FIG. 3 is a flow chart of a process (or processes) by which an instruction sequence is prepared for profiling, by which profile data is collected and by which optimized code is prepared (or re-prepared) based on the collected data. Identification, collection and optimization facilities may be implemented and/or performed separately, or in combination with one or both of the others. Program code 301 includes any of a variety of embodiments of an original instruction sequence (such as illustrated in FIG. 2) including as compiled code, schedulable code (e.g., an intermediate compiler form) in which memory operations have been made explicit, virtual machine instructions, etc. Target instructions in the original instruction sequence are identified (311) and instruction identifiers are appropriately stored. In some realizations, a separate store of instruction identifiers 302 may be maintained. Alternatively, or in addition, instruction identifiers may be encoded in the program code itself. Such an approach may be particularly attractive in realizations where program code 301 is represented in an intermediate data structure of a compiler or other code preparation facility. Ambiguity-creating locations in the original instruction sequence are identified (312) and instruction identifiers are appropriately stored. As with target instructions, ambiguity-creating locations may be represented in a separate store of instruction identifiers 302 or encoded in the program code itself, or both.

The set of relevant target instructions is, in general, program code dependent and implementation specific. However, for a desired set of event detections, determination of the relevant set is straightforward. For example, focusing illustratively on a memory access related execution event set characteristic of the UltraSPARC III processor, data cache read misses (or hits), data cache write misses (or hits), load/store stall cycles, and store queue stall cycles may be of interest. In some cases, execution events may differentiate between events (e.g., misses, stalls, etc.) at various pipeline stages. Although the relevant corresponding sets of target instructions are processor instruction set specific, persons of ordinary skill in the art will appreciate appropriate correspondence based on the following example(s). Generally, corresponding target instruction(s) for a data cache write miss execution event are the various store-type instructions implemented by a particular processor architecture. Similarly, corresponding target instruction(s) for a data cache read miss execution event are the various load-type instructions. Data cache stall cycle execution events (e.g., for a page fault) may correspond to either load-type or storetype instructions.

In some realizations, execution events may include events not associated with memory access (e.g., pipeline stalls, exception conditions, etc.) for which corresponding instruction targets may be identified. In general, correspondence of execution events with candidate target instructions will vary based on processor architecture and implementation. However, based on the description herein, persons of ordinary skill in the art will appreciate sets of execution events and corresponding target instructions suitable for a particular implementation.

The set of relevant ambiguity-creating locations is also program code dependent and implementation specific. However, in practice, most ambiguities trace to control transfers. For example, branch target locations, entry point locations, jump target locations, indirect branch target locations, trap handler locations, interrupt handler locations, etc. may all create execution path ambiguity. Based on the description herein, persons of ordinary skill in the art will appreciate sets of ambiguity-creating locations suitable for a particular implementation.

Referring again to FIG. 3, program code 301 (or executable code corresponding thereto) is executed to generate event profile information. Any of a variety of conventional profiling methods may be employed. For example, in a typical hardware assisted profiling environment, particular instances of an event type (e.g., a statistically sampled occurrence of a particular type of cache miss) triggers a sampling of an execution event (e.g., based on overflow of a corresponding hardware counter). Whatever the particular technique employed, execution event information may be accumulated in a separate profile store 303 and/or represented in conjunction with program code 301.

Collection associates particular occurrences of an execution event with a coinciding point in the original execution sequence of program code 301. Often, multiple program runs, perhaps involving differing data sets, will be employed to generate profile data. For purposes of description, either an underlying execution event itself (e.g., a stage N read miss in the data cache) or an associated hardware event (e.g., overflow or underflow of an associated counter) may be viewed as the execution event with which a point in the original execution sequence of program code 301 coincides. Often, a program counter value serves to identify the coinciding point.

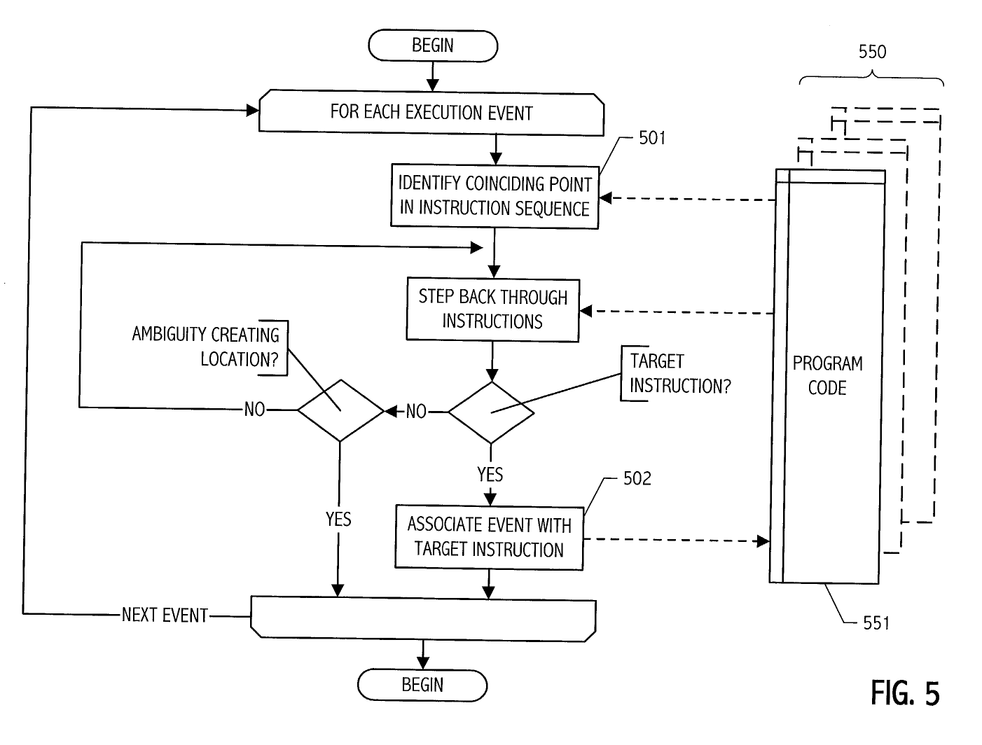

Based on the coinciding points and on the previously identified target instructions and ambiguity-creating locations, collection 320 attempts to associate detections of a particular execution event with a proper target instruction from the original execution sequence of program code 301. A backtracking technique is illustrated in FIG. 5; however, at least some suitable techniques will be understood as follows. Beginning at the coinciding point for a particular execution event detection, collection steps back through the original execution sequence in an attempt to find a preceding target instruction (i.e., an instruction of appropriate type to have triggered the detected event). In some realizations, an expected displacement is reasonably fixed and may place an upper bound on the backtracking. If no intervening ambiguity-creating location is encountered, association is straightforward. When an intervening ambiguity-creating location such as a branch target is encountered, then the particular execution event instance may be ignored in the preparation of profile data. Alternatively, if some facility such as a branch history queue is provided, it may be possible to resolve the ambiguity and backtrack along a proper execution path.

In either case, profile data is accumulated for associable target instructions. Typically, profile data is aggregated to provide a statistically valid characterization of individual target instructions based on criteria corresponding to the detected execution event. For example, a particular instruction for which collection indicates a normalized cache miss rate above a predetermined value maybe deemed to be a “likely cache miss.” Other suitable characterizations are analogous.

Depending on the implementation, the original instruction sequence of program code 301 may optimized, e.g., through recompilation 330, based on profile data 303. As previously described, some exploitations may encode profile data (or instruction characterizations corresponding thereto) in program code 301, e.g., as compiler hints.

For purposes of illustration, instruction identification, collection and code optimization are depicted as separable phases although they need not be in all realizations. Also, although some realizations in accordance with FIG. 3 reduce profile data to a characterization (e.g., likely cache hit or likely cache miss) suitable use by a compiler in optimization decisions, other realizations may provide such data (or even raw or less processed precursors thereof) for programmer feedback or to a compiler, profiler suite or other code development tool. As a general matter, particular selections, aggregations and or characterizations of profile data are matters of design choice and any of a variety of choices is suitable.

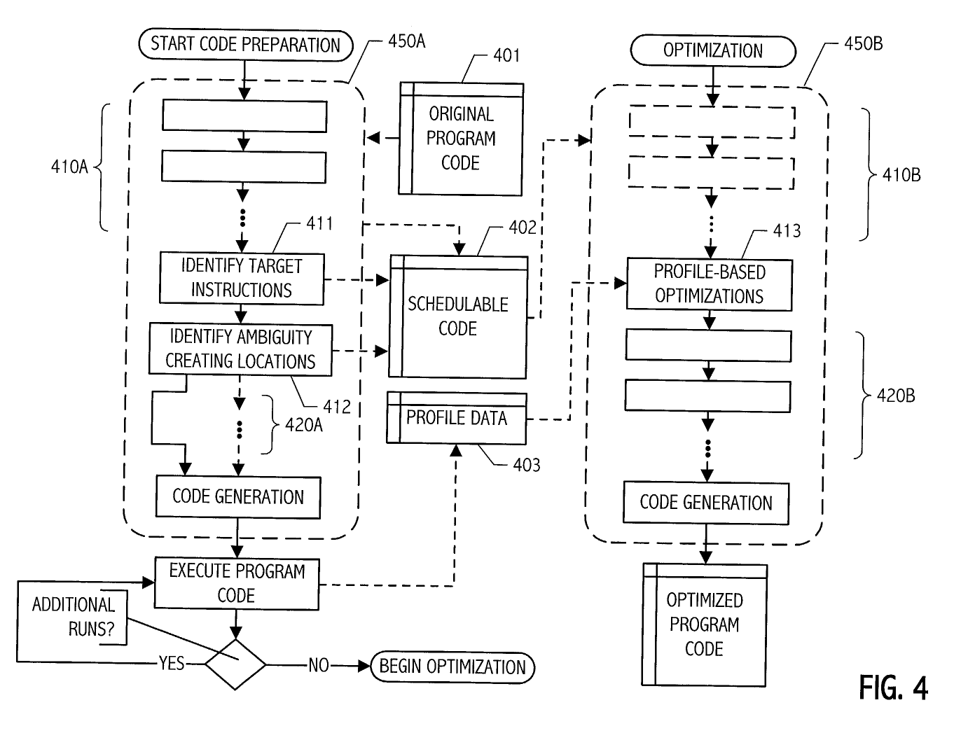

The flow chart of FIG. 4 illustrates a variation on the techniques previously described whereby executable code is prepared for profiling (e.g., by a feedback directed optimizing compiler) in which certain later stages of optimization are initially forgone. Then, based on profile data obtained, these previously forgone optimizations are performed to generate optimized program code. Original program code 401 includes any of a variety of functional program representations that include an original instruction sequence (such as illustrated in FIG. 2) including as compiled code, schedulable code (e.g., an intermediate compiler form) in which memory operations have been made explicit, virtual machine instructions, etc.

Using techniques in accordance with the present invention, executable code is prepared for data collection then optimized (or re-optimized) based on collected data. In some realizations, code preparation functionality 450A and 450B are provided by successive executions of a single optimizing compiler implementation, typically with differing optimization levels or selections. In other realizations, separate facilities may be employed. In the case of a combined facility, code preparation functionality 450A exercised during preparation of code for profiling may differ from code preparation functionality 450B exercised for optimization. In particular, while an initial set 410A of optimizations, e.g., loop unrolling, common sub-expression identification, dead code elimination, etc., are often performed prior to identifying (411, 412) target instructions and ambiguity-creating locations in original program code 401, certain additional optimizations 420A may be forgone in the preparation of code for profiling. Although not specifically illustrated, all optimizations need not be performed prior to identification (411, 412) of target instructions and/or ambiguity-creating locations. For example, identified instructions or locations may be propagated through some optimization steps, e.g., as duplicates after loop unrolling, in some implementations.

In general, the forgone optimizations include those that are based on profile information (e.g., prefetch optimizations that may be undertaken based on target instructions identified as likely-cache-misses or otherwise likely-to-stall) and those that tend to complicate or interfere with data collection and/or association with instructions. For example, in some realizations for SPARC processor architecture code, exploitation of delay slot instruction positions may be forgone in the preparation of code for profiling.

As before, profile data 403 is obtained based on program execution. Using the obtained data, certain profile-based optimizations (413) may be employed. As before, prefetch optimizations such as described in the above-incorporated U.S. patent application Ser. No. 09/996,088 are illustrative, though realizations in accordance with the present invention are not limited thereto. In general, techniques of the present invention may be employed in any of a variety of profile-directed compiler or optimizer configurations. As illustrated in FIG. 4, previously forgone optimizations may now be performed (420B). Depending on the implementation, the initial set (410A) of optimizations may be re-performed (410B) or an intermediate compiler data structure state of schedulable code 402 (e.g., that resulting from profile code preparation with profile data represented therein) may be employed as a starting point for the code preparation functionality 450B exercised for optimization.

FIG. 5 is a flow chart illustrating one suitable backtracking implementation. For each execution event, a coinciding point is identified (501) in an instruction sequence. Typically, the coinciding point is identified using a then current program counter value at or about the time or point of detection. More generally, any facility which establishes a coinciding point may be employed. Beginning at the coinciding point for a particular execution event detection, collection steps back through the instruction sequence in an attempt to find a preceding target instruction (i.e., an instruction of appropriate type to have triggered the detected event). As the backtracking progresses, if a target instruction is encountered without an intervening ambiguity-creating location, then the detected execution event is associated (502) with the target instruction. If, on the other hand, an intervening ambiguity-creating location is encountered, then the execution event is discarded and the process continues with the next execution event. In some realizations, an expected displacement is reasonably fixed and may place an upper bound on the backtracking. Also, as previously described, ancillary information (not specifically shown) such as from a branch history queue may be employed in some realizations to bridge ambiguity-creating locations and thereby backtrack along a proper execution path.

As before, target instructions and ambiguity-creating locations may be identified in a representation 551 of program code and/or in separate stores or data representations 550. Similarly, associations of execution events (or aggregated data based thereon) may be added to a representation of the program code, e.g., as compiler hints, and/or represented in separate stores or data representations 550.

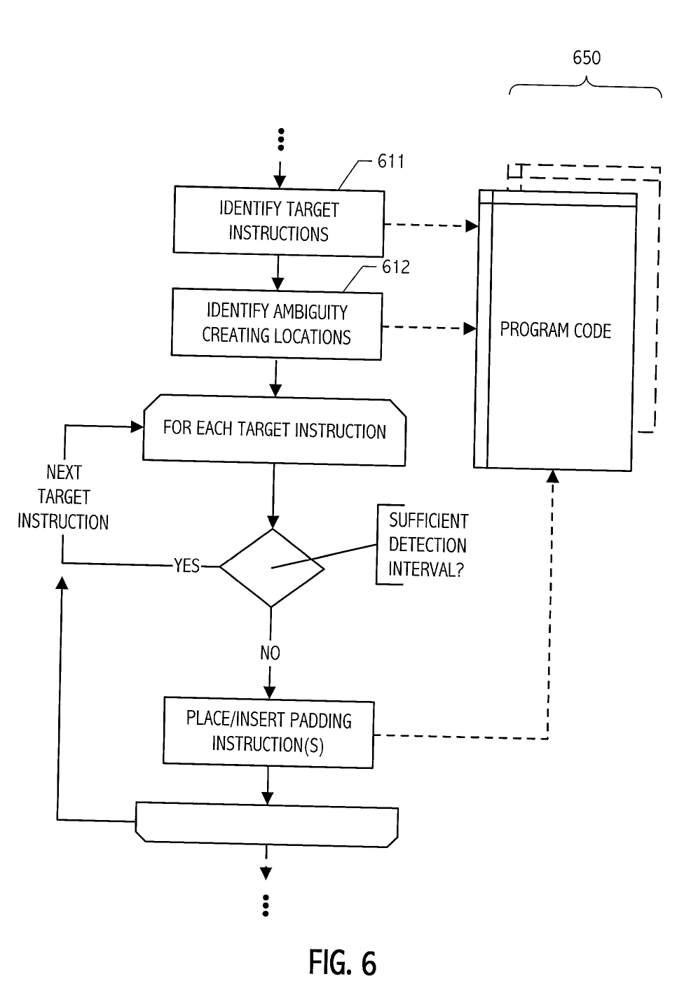

Building on the insights developed above, it may be desirable in some implementations to avoid or minimize ambiguity-creating locations in code to be profiled. Accordingly, FIG. 6 depicts a flow chart illustrating preparation of an instruction sequence that includes an unambiguous skid region to facilitate profiling. As before, target instructions and ambiguity-creating locations are identified (611, 612) in original program code. Then, based on an expected detection interval appropriate for the executing processor implementation and based on a relevant set of execution events, we determine whether a sufficient detection interval (defined by a sequence of instructions) exists to allow association of an event detection with a corresponding target instruction without an intervening ambiguity-creating location. If so, we move on to the next target instruction. If not, one or more padding instructions are placed or inserted to provide the desired detection interval. In some realizations, padding instructions may be null operations (nops) inserted into the original instruction sequence. In some realizations, particularly compiler implementations, opportunities may exist to opportunistically place or schedule instructions to provide at least some portion of the desired detection interval for some target instructions.

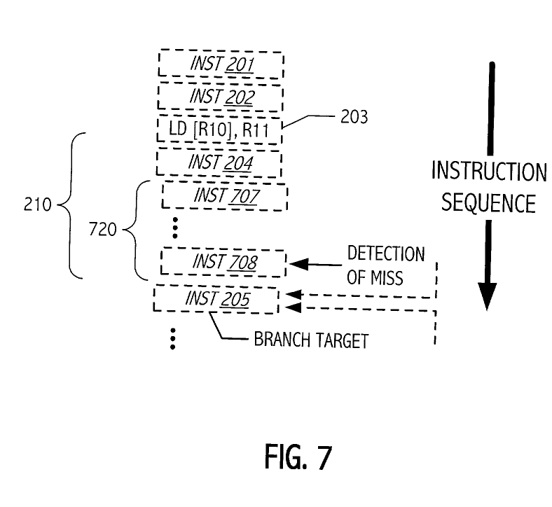

In either case, the placement or insertion of padding instructions or operations will be further understood in the context of FIG. 7, which depicts an instruction sequence that includes instructions 720 (potentially nops) that at least partially provide an unambiguous skid region to facilitate association of execution events with target instructions. In the illustrated sequence of FIG. 7, part of expected event detection latency 210 is covered by instruction 204 from the original instruction sequence and part is covered by placed or inserted instructions 720.

While the invention has been described with reference to various embodiments, it will be understood that these embodiments are illustrative and that the scope of the invention is not limited to them. Many variations, modifications, additions, and improvements are possible. For example, while much of the description herein has focused on the illustrative context of cache miss related execution events and memory access target instructions, applications to other execution events and related profiling are also envisioned. Similarly, although instruction profiling has been presumed, techniques described herein may be more generally applied to operations of processor, pipeline or execution unit, whether such operations correspond one-to-one with instructions of an instruction set or are lowerlevel or higher-level operations performed by a particular implementation of a target architecture. For example, based on the description herein, persons of ordinary skill in the art will appreciate extensions to operations executable by a microcoded processor implementation or virtual machine implementation.

More generally, realizations in accordance with the present invention have been described in the context of particular embodiments. These embodiments are meant to be illustrative and not limiting. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

WHAT IS CLAIMED IS:

1. A method of profiling code for an execution environment in which latency exists between an execution event and detection thereof, the method comprising:
executing the code;
detecting the execution event; and
backtracking from a point in the code coinciding with the detection to a preceding operation associated with the execution event, the backtracking identifying the preceding operation at an expected displacement from the detection point unless an ambiguity creating location is disposed therebetween.

2. The method of claim 1,
wherein the ambiguity creating location is a branch target location.

3. The method of claim 2,
wherein ambiguity otherwise associated with at least some branch target locations is bridged using branch history information.

4. The method of claim 1,
wherein the ambiguity creating location is an entry point location.

5. The method of claim 1, wherein the ambiguity creating location is one of:
ajump target location;
an indirect branch target location;
a trap handler location; and an interrupt handler location.

6. The method of claim 1,
wherein the preceding operation corresponds to a load instruction; and
wherein the execution event is a cache miss.

7. The method of claim 1,
wherein the preceding operation corresponds to a memory access instruction; and
wherein the execution event is either a hit or a miss at a level in a memory hierarchy.

8. The method of claim 1,
wherein the execution event is either a overflow or an underflow of a hardware counter.

9. The method of claim 1,
wherein the execution event triggers either a overflow or an underflow that is itself detected.

10. The method of claim 1,
wherein the latency includes that associated with delivery of a trap.

11. The method of claim 1,
wherein the latency includes that associated with delivery of a counter overflow event signal.

12. The method of claim 1,
wherein the latency is associated with pipeline execution skid.

13. The method of claim 1,
wherein the latency is associated with completion of in-flight operations.

14. The method of claim 1, embodied in a computer program product.

15. The method of claim 1, embodied in at least one of:
a profiling tool;
a code optimizer; and
a runtime library.

16. The method of claim 1, employed in combination with a compiler that pads the code with one or more padding operations to absorb at least some instances of the latency.

17. The method of claim 16,
wherein the padding operations are not themselves associated with the execution event.

18. The method of claim 16,
wherein the padding operations are not themselves ambiguity creating locations.

19. A method of identifying operations associated with execution events, the method comprising:
from a point in an execution sequence of the operations, the point coinciding with an execution event, backtracking through the operations toward a particular operation that precedes the coinciding point by an expected latency; and
associating the execution event with the particular operation unless the backtracking encounters an unresolved intervening target of a control transfer.

20. The method of claim 19, further comprising:
executing the sequence of operations on a processor; and
detecting the execution event.

21. The method of claim 19,
wherein the operations are instructions executable on a processor; and
wherein the particular operation is a particular one of the instructions that triggers the execution event.

22. The method of claim 19,
wherein the operations are executable on a processor and correspond to instructions of program code; and
wherein the particular operation corresponds to a particular one of the operations that triggers the execution event.

23. The method of claim 19,
wherein the execution event is an exception triggering execution of the particular operation.

24. The method of claim 19,
wherein the execution event is a cache miss.

25. The method of claim 19,
wherein the expected latency includes an trap delivery delay.

26. The method of claim 19,
wherein the execution event triggers a hardware event and the expected latency includes delivery of a signal associated therewith.

27. The method of claim 26,
wherein the hardware event is either underflow or overflow of a counter associated with the execution event.

28. The method of claim 19,
wherein the execution event is either underflow or overflow of a counter.

29. The method of claim 19,
wherein instances of intervening control transfer targets are identified in the execution sequence of operations to facilitate the backtracking.

30. The method of claim 29,
wherein at least some of the instances of intervening control transfer targets are resolved using branch history information.

31. The method of claim 19,
wherein control transfer target locations in the execution sequence are identified by a compiler.

32. The method of claim 19,
wherein the operations are instructions executable on a processor; and
wherein the particular operation is a particular one of the instructions that triggers the execution event.

33. The method of claim 19,
wherein the operations are executable on a processor and correspond to instructions of program code; and
wherein the particular operation corresponds to a particular one of the operations that triggers the execution event.

34. The method of claim 19, further comprising:
preparing the execution sequence of the operations.

35. The method of claim 34,
wherein preparation of the execution sequence includes identifying a location of the control transfer target therein.

36. The method of claim 34,
wherein preparation of the execution sequence includes identifying a location of the particular operation therein.

37. The method of claim 19,
wherein the particular operations include memory referencing instructions.

38. The method of claim 37,
wherein the memory referencing instructions include one or more of loads, stores and prefetches.

39. A method of associating an execution characteristic of code with a particular operation thereof, the method comprising:
identifying at least first-type and second-type operations in the code;
from a point in an execution sequence of the code that coincides with delayed detection of the execution characteristic, backtracking toward a candidate triggering operation of the first-type and associating the candidate triggering operation with the execution characteristic unless an unresolved intervening operation of the second-type is encountered.

40. The method of claim 39,
wherein the first-type operations include memory access operations.

41. The method of claim 39,
wherein the second-type operations include operations that coincide with control transfer target locations in the code.

42. The method of claim 39,
wherein the execution characteristic involves memory access latency.

43. The method of claim 39,
wherein the execution characteristic includes a cache miss statistic.

44. The method of claim 39,
wherein the detection delay includes a pipelined execution skid latency.

45. The method of claim 39,
wherein the second-type operations include operations that coincide with branch target locations in the code; and
wherein at least some of the branch target locations are resolved using branch history information.

46. A method of preparing code, the method comprising:
preparing a first executable instance of the code, the preparing identifying at least ambiguity creating locations therein;
executing the first executable instance and responsive to detection of an execution characteristic, backtracking through the code to identify an associated operation thereof, wherein extent of the backtracking is limited at least by encountering of an unresolved intervening one of the identified ambiguity creating locations; and
further preparing a second executable instance of the code using the association between the associated operation and the execution characteristic.

47. The method of claim 46,
wherein the association between the associated operation and the execution characteristic is based on a statistically-significant set of additional detections and responsive backtracking.

48. The method of claim 46,
wherein the execution characteristic involves memory access latency; and
wherein the preparation of the second executable instance includes insertion of prefetch operations into the code.

49. The method of claim 46, further comprising:
resolving at least some intervening ones of the identified ambiguity creating locations using branch history information.

50. A computer program product encoded in one or more computer readable media, the computer program product comprising:
an execution sequence of operations; and
padding operations following at least some particular operations of the execution sequence, the padding operations providing an unambiguous skid region of the execution sequence.

51. The computer program product of claim 50,
wherein the particular operations include memory access operations.

52. The computer program product of claim 50,
wherein the padding operations include nops.

53. The computer program product of claim 50,
wherein the unambiguous skid region does not include an ambiguity creating location.

54. The computer program product of claim 50,
wherein the one or more computer readable media are selected from the set of a disk, tape or other magnetic, optical, semiconductor or electronic storage medium and a network, wireline, wireless or other communications medium.

55. A computer program product encoded in one or more computer readable media, the computer program product comprising:
an execution sequence of operations; and
one or more data sections that identify in the execution sequence at least ambiguity creating locations and target operations for use by one or both of a profiler and a optimizer.

56. The computer program product of claim 55,
wherein the ambiguity creating locations include branch target locations.

57. The computer program product of claim 55,
wherein the target operations include memory referencing operations.

58. The computer program product of claim 55,
wherein the one or more computer readable media are selected from the set of a disk, tape or other magnetic, optical, semiconductor or electronic storage medium and a network, wireline, wireless or other communications medium.

59. An apparatus comprising:
means for backtracking, from a point coinciding with an execution event in an execution sequence of operations, through the execution sequence toward a particular operation thereof that precedes the coinciding point; and
means for associating the execution event with the particular operation unless the backtracking encounters an intervening ambiguity creating location.

60. The apparatus of claim 59, further comprising:
means for bridging at least some ambiguity creating locations.

61. An apparatus comprising:
a code preparation facility suitable for preparation of an execution sequence of operations; and
means for padding the execution sequence to provide an unambiguous skid region therein.
